(19) United States
(12) Patent Application Publication
(10) Pub. No.: US 2025/0245600 A1
(43) Pub. Date: Jul. 31, 2025

(54) METHOD AND SYSTEM FOR ENHANCING SALES REPRESENTATIVE PERFORMANCE USING MACHINE LEARNING MODELS

(71) Applicant: Dell Products L.P., Round Rock, TX (US)

(72) Inventors: Anna Popova, Murphy, TX (US); Ravi Shukla, Bengaluru (IN); Ramakanth Kanagovi, Hyderabad (IN); Khauneesh Saigal, Noida (IN); Trishit Roy, Bengaluru (IN); Gaurav Bhattacharjee, Bangalore (IN); Saheli Saha, Kolkata (IN); Shyama Kadavarath Unnikrishnan, Bangalore (IN); Vinod Babu Palani, Chennai (IN)

(21) Appl. No.: 18/422,964

(22) Filed: Jan. 25, 2024

(51) Int. Cl. G06Q 10/0639; G06N 5/022

(52) U.S. Cl. CPC G06Q 10/06393; G06N 5/022; G06Q 10/06398

(57) ABSTRACT

A method for managing a sales representative's (SR) performance includes: obtaining historical sales drivers (HSDs); generating, using the HSDs, an analysis model that identifies a set of key sales drivers and target cut-off values associated with the set of key sales drivers; obtaining, based on a target parameter, a trained analysis model that is trained using at least the HSDs; obtaining historical key sales drivers (HKSDs), internal parameters (IPs), and external parameters (EPs); analyzing the HKSDs, the IPs, and the EPs to generate an insights model that provides an insight for the SR; obtaining, based on the target parameter, a trained insights model that is trained using at least the HKSDs, the IPs, and the EPs; notifying an analyzer about the trained insights model; and initiating, by the analyzer, notification of an administrator about the trained analysis model and the trained insights model.

### BACKGROUND

Devices are often capable of performing certain functionalities that other devices are not configured to perform, or are not capable of performing. In such scenarios, it may be desirable to adapt one or more systems to enhance the functionalities of devices that cannot perform those functionalities.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example, and are not meant to limit the scope of the claims.

FIG. 1 shows a diagram of a system in accordance with one or more embodiments disclosed herein.

FIG. 2.1 shows a diagram of an infrastructure node in accordance with one or more embodiments disclosed herein.

FIG. 2.2 shows example historical sales drivers and example key sales drivers in accordance with one or more embodiments disclosed herein.

FIG. 2.3 shows a portion of an analysis model implemented by an analyzer in accordance with one or more embodiments disclosed herein.

FIG. 2.4 shows an example weekly driver value and target table in accordance with one or more embodiments disclosed herein.

FIG. 2.5 shows an example high-priority sales quote in accordance with one or more embodiments disclosed herein.

FIG. 3.1 shows a method for generating the analysis model in accordance with one or more embodiments disclosed herein.

FIG. 3.2 shows a method for generating an insights model in accordance with one or more embodiments disclosed herein.

FIGS. 4.1 and 4.2 show a method for sales representative (SR) performance tracking in accordance with one or more embodiments disclosed herein.

FIG. 5 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, as a business operates, revenue and margin are generated and tracked in “quarters” of a year (e.g., a three-month period). To this end, much of the determination of potential risks and opportunities are identified and tracked “by quarter”. This determination often revolves around a key issue(s), such as: (i) estimating how much revenue is likely to be generated by the end of the quarter, (ii) identifying sales that diverge from their estimated revenue, (iii) attainment/performance (e.g., revenue divided by revenue target), (iv) identifying the risks in meeting the revenue target, (v) estimating demand in a sales pipeline to meet the revenue target, and/or (vi) in the event of a risk, quantifying the additional demand needed to mitigate the identified risks.

Often businesses already measure and store a vast amount of data that may provide significant insights into the ongoing operations of the businesses. By applying data science techniques to this data, businesses may extract revenue trends and patterns, and use them to better predict revenue (e.g., generate more accurate forecasts), thereby helping sales teams (e.g., SRs, sales people, sales managers, etc.) to be better prepared to handle potential gaps in meeting revenue targets.

This data may also be used to predict revenue (or sales revenue) that is sensitive to changes in macro trends. This may be particularly useful in an uncertain economic climate, in which global events may quickly impact a business's revenue streams. By leveraging data science techniques, businesses may model the best, worst, and likely scenarios of revenue attainment-thereby providing a more comprehensive view of the potential risks and opportunities they may face.

Further, engineering this data may help businesses derive quantitative factors impacting revenue. By understanding the key factors/metrics that drive revenue, businesses may make better informed decisions about how to mitigate potential risks and capitalize on opportunities. This data may also be wielded to quantify risk and risk mitigation measures, allowing businesses to better understand the potential impact of different risks and how to address those risks.

The data elements that are most useful for determining specific actions to mitigate sales risk may vary depending on the specific business and its operations. Generally, factors that are most critical to meeting a revenue target include: (i) target for the current quarter, (ii) sufficiency of current deals in a sales pipeline to meet the target, (iii) percentage of a sales pipeline at risk, (iv) deals that need additional attention, (v) factors contributing to risky deals, and (vi) actions needed to avert risky deals. Accordingly, by identifying the data elements that are most relevant to the business, a sales team may be better equipped to handle potential risks and work towards meeting revenue targets.

Further, the revenue target for a sales region (and the business overall) may be composed of the individual sales targets for respective SRs. Accordingly, each SR may generate a sales pipeline to engage demand and meet their revenue target for a given quarter. To satisfy a revenue target, it may be vital to evaluate a sales pipeline for sales opportunities/deals in advance, activate SRs on specific opportunities for specific customers, and mitigate any risk factors that may prevent a deal from moving forward.

A recent study shows that machine learning (ML) models (e.g., ML analytics tools and technologies) may improve sales processes, identify sales opportunities, resolve sales challenges (e.g., risk factors), and/or enhance the overall sales performances of an organization. For example, one of the reasons for the sales deals failing to close is the lack of a system that can predict risk factors for a sales deal that considers both data patterns and human intelligence. Typically, real-time access and volume of information (e.g., customer's intention, previous actions of an SR (e.g., deal calls with a customer, engagement trips with the customer, etc.), events, news, etc., coming from both internal and external data sources) to process regarding a customer (or a customer account) requires agility. Agility of this information is vital to support ever changing customer requirements without loss of information regarding historical interactions (with the customer) and purchases (made by the customer).

Further, even with such information, risk identification needs to be provided early in the quarter in order to provide an SR with sufficient time to manage possible risks (e.g., delivering a personalized pitch to a customer, taking actions based on the customer's pain points in order to improve the customer's engagement with the SR, etc.). Otherwise, by the time the SR becomes aware of any risk to an ongoing deal, it may be too late to mitigate the loss of that deal.

As yet another example, the complexity of products, solutions, segment hierarchy, and SR attributes may all play a role in revenue prediction (where businesses may develop a more comprehensive and accurate view of their potential revenue and risks), and these factors hinge on hundreds of cross-sectional and time series data points. As indicated in this example, SRs may need to be able to articulate (i) complex solution propositions and (ii) best practices of positioning products to increase chances of successful business-to-business partnerships (e.g., businesses with complex products may face unique challenges in predicting revenue, as the sales process for these products may be more difficult to model).

On the other hand, the hierarchy of a business's segments and the attributes of its sales teams may impact revenue prediction, and these factors should be considered when forecasting revenue. As indicated, absence of tie off in strategic initiatives (to consider the aforementioned factors) may affect, at least, (i) the business's sales compensation, (ii) the business's top-down strategy and/or bottom-up strategy, and (iii) day-to-day activities of SRs.

As yet another example, conventional approaches generally focus on sales efforts that deliver on one or more drivers (e.g., revenue drivers, sales drivers, etc.) that may or may not contribute to revenue growth (e.g., of an SR, of an organization, etc.) without any prioritization and specificity with respect to the SR's role-region-segment details. This may cause skewed results towards certain proportion of SRs and most SRs may not know what to focus on (e.g., for revenue growth) and what target needs to be achieved for each driver.

As yet another example, while performing sales activities (e.g., quote conversion, pricing, etc.), SRs usually (i) web search for external/additional details of customers/accounts and (ii) utilize business intelligence applications to obtain/retrieve internal information (associated with the customers) for an engagement with a potential customer. However, performing web searches and utilizing business intelligence applications require resource-intensive (e.g., time, engineering, etc.) efforts (from an SR).

For at least the reasons discussed above and without requiring resource-intensive efforts, a fundamentally different approach/framework is needed (e.g., an approach that (i) leverages ML models (as an insights aggregator platform) to address the aforementioned challenges, (ii) is flexible enough to automate top-down strategic initiatives and bottom-up execution of sales journeys for each SR, and (iii) accurately predicts revenue of a business and help the business to better understand and manage the risks to manage their revenue targets).

Embodiments disclosed herein relate to methods and systems for resolving current challenges an SR is facing on a daily basis and managing the SR's performance. As a result of the processes discussed below, one or more embodiments disclosed herein advantageously ensure that: (i) a useful ML-based (or data science-based) framework (that includes, for example, sales analytics, insights, predictive actions, key sales drivers, internal and external information with respect to customers, etc.) is provided to an SR to (a) increase his/her sales productivity (or sales performance in terms of revenue attainment) on both quarterly and semi-annual compensation structures and (b) automate the SR's tasks/duties for a better SR experience (e.g., higher job satisfaction, minimizing chances of burnout in a SR position because of magnitude of actions that an SR need to do, guiding the SR with respect to high amount of time-sensitive tasks, etc.); (ii) internally and externally obtained data is engineered (via one or more end-to-end linear, non-linear, and/or ML models) to help businesses to derive quantitative factors/metrics/trends impacting revenue so that businesses may make better informed decisions (based on different scenarios), for example, how to mitigate potential risks and capitalize on opportunities (e.g., by predicting the likelihood of deals that are not proceeding (to close) on their respective scheduled date); (iii) based on (ii), risk mitigation measures are provided to businesses to allow the businesses to better infer the potential impact of different risks and how to address those risks (e.g., towards meeting their revenue targets based on specific business operations); (iv) SRs are provided/equipped with the ability to proactively identify revenue target attainment risks and be aware of key sales/actionable drivers (or key factors that actually contribute to revenue growth of the SRs at the role-region-segment level) that cause the risk; (v) based on (iv), the SRs can handle potential risks and operate towards meeting their revenue targets; (vi) an SR's sales effort (and his/her engagement with potential customers) is optimized with the help of (a) key sales drivers for revenue growth and (b) an explainable artificial intelligence (AI) driven sub-framework (where this sub-framework identifies the best performing threshold value of each key sales driver); (vii) key sales drivers and their corresponding thresholds are generated at the role-region-segment level (in order to provide swim lanes (to SRs) with different responsibilities aligned with their capabilities); and/or (viii) a large language model (LLM) and a web application programming interface (web API) based sub-framework is provided to an SR, in which this sub-framework curates both internal and external information specific to sales activities (e.g., sales quotes) prioritized by an analysis model (that includes the aforementioned explainable AI driven sub-framework) to (a) increase resource usage efficiency of the SR and (b) increase the SR's performance with a better SR experience.

The following describes various embodiments disclosed herein.

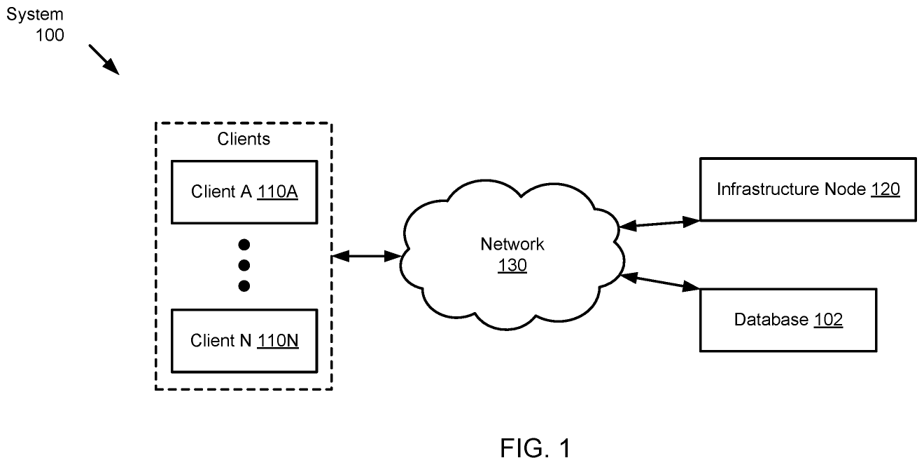

FIG. 1 shows a diagram of a system (100) in accordance with one or more embodiments disclosed herein. The system (100) includes any number of clients (e.g., Client A (110A), Client B (110B), etc.), a network (130), any number of infrastructure nodes (INs) (e.g., 120), and a database (102). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110B, etc.), the IN (120), the network (130), and the database (102) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110B, etc.) and the IN (120) are shown to be operatively connected through a communication network (e.g., 130), the clients (e.g., 110A, 110B, etc.) and the IN (120) may be directly connected (e.g., without an intervening communication network).

Further, the functioning of the clients (e.g., 110A, 110B, etc.) and the IN (120) is not dependent upon the functioning and/or existence of the other components (e.g., devices) in the system (100). Rather, the clients and the IN may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

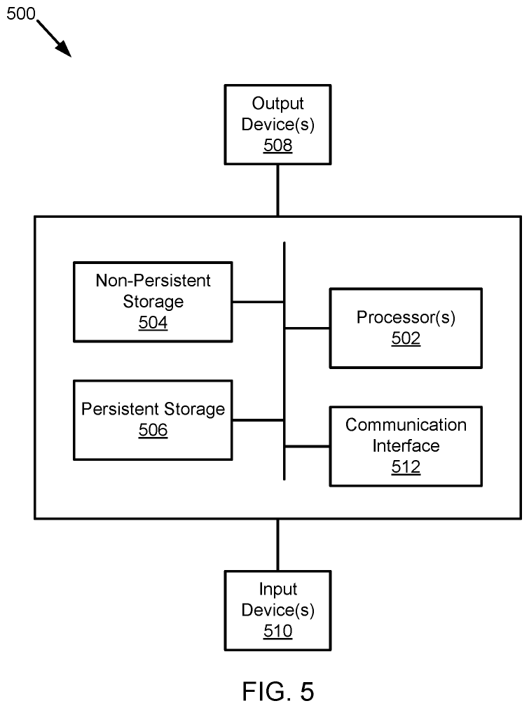

In one or more embodiments, the system (100) may be a distributed system (e.g., a data processing environment) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., 110A, 110B, etc.). For example, the system may be configured to organize unbounded, continuously generated data into a data stream. The system (100) may also represent a comprehensive middleware layer executing on computing devices (e.g., 500, FIG. 5) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users' site using the clients (e.g., 110A, 110B, etc.)) and other computations remotely (e.g., away from the users' site using the IN (120)) from the users. By doing so, the users may utilize different computing devices (e.g., 500, FIG. 5) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110B, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IN (120)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110B, etc.) may be geographically distributed devices (e.g., user devices, front-end devices, etc.) and may have relatively restricted hardware and/or software resources when compared to the IN (120). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110B, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110B, etc.) may correspond to computing devices that one or more users use to interact with one or more components of the system (100).

In one or more embodiments, a client (e.g., 110A, 110B, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110B, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110B, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110B, etc.) may utilize, rely on, or otherwise cooperate with the IN (120). For example, the clients may issue requests to the IN to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by the IN. When the clients interact with the IN, data that is relevant to the clients may be stored (temporarily or permanently) in the IN.

In one or more embodiments, a client (e.g., 110A, 110B, etc.) may be capable of, e.g.,: (i) collecting users' inputs, (ii) correlating collected users' inputs to the computer-implemented services to be provided to the users, (iii) communicating with the IN (120) that perform computations necessary to provide the computer-implemented services, (iv) using the computations performed by the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the clients (e.g., 110A, 110B, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110B, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110B, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the IN (120)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110B, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110B, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110B, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of DRAM and 1 CPU with 12 cores, whereas Client N (110N) may have 8 GB of PMEM and 1 CPU with 16 cores. Other different computational capabilities of the clients not listed above may also be taken into account without departing from the scope of the embodiments disclosed herein.

Further, in one or more embodiments, a client (e.g., 110A, 110B, etc.) may be implemented as a computing device (e.g., 500, FIG. 5). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110B, etc.) may be implemented as a logical device (e.g., a VM). The logical device may utilize the computing resources of any number of computing devices to provide the functionality of the client described throughout this application.

In one or more embodiments, users (e.g., customers, administrators, people, etc.) may interact with (or operate) the clients (e.g., 110A, 110B, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing the virtualization technology. In one or more embodiments, an administrator may be a user with permission (e.g., a user that has root-level access) to make changes on the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 500, FIG. 5) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, the IN (120) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (120) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110B, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the database (102) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or ML models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide software-defined data protection for the clients (e.g., 110A, 110B, etc.); (xii) provide automated data discovery, protection, management, and recovery operations for the clients; (xiii) monitor operational states of the clients; (xiv) regularly back up configuration information of the clients to the database (102); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or database; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (120) may communicate with, for example, the database (102) and/or other storage devices in the system (100).

As described above, the IN (120) may be capable of providing a range of functionalities/services to the users of the clients (e.g., 110A, 110B, etc.). However, not all of the users may be allowed to receive all of the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

For example, the priority (e.g., the user access level) of a user may be used to determine how to manage computing resources of the IN (120) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN (120) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110B, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) the IN (120) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, OS data, etc.), medium workloads with higher priority (e.g., VM with FS data, network data management protocol (NDMP) data, etc.), large workloads with critical priority (e.g., mission critical application data), etc.

Further, while a single IN (120) is considered above, the term “node” includes any collection of systems or sub-systems that individually or jointly execute a set, or multiple sets, of instructions to provide one or more computer-implemented services. For example, a single IN may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (120) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, the IN (120) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

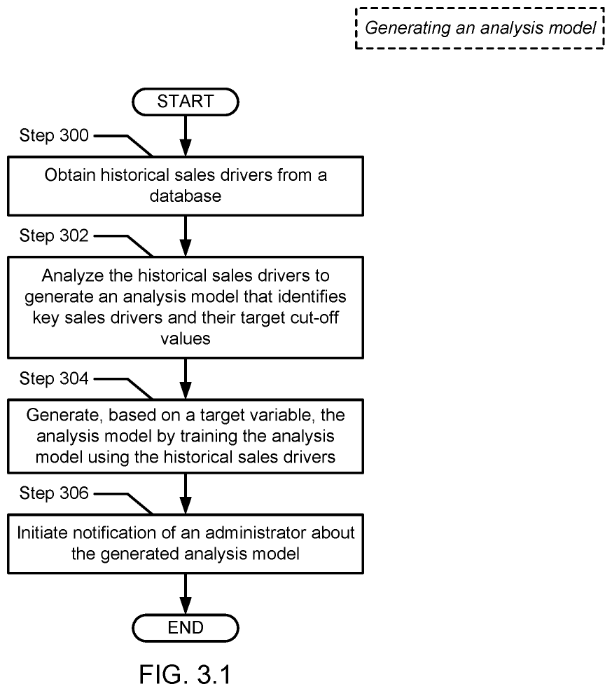

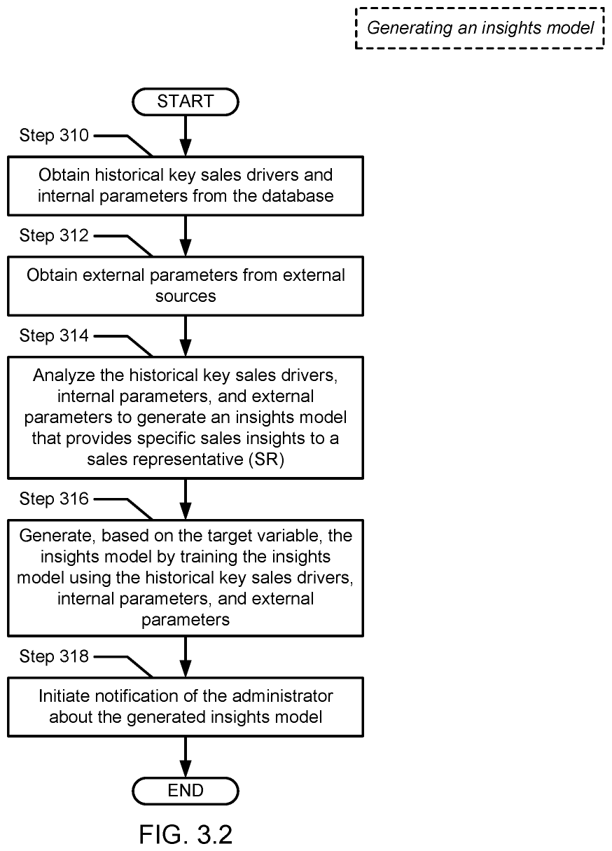

One of ordinary skill will appreciate that the IN (120) may perform other functionalities without departing from the scope of the embodiments disclosed herein. In one or more embodiments, the IN may be configured to perform (in conjunction with the database (102)) all, or a portion, of the functionalities described in FIGS. 3.1-4.2.

In one or more embodiments, the IN (120) may be implemented as a computing device (e.g., 500, FIG. 5). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110B, etc.), the IN may also be implemented as a logical device.

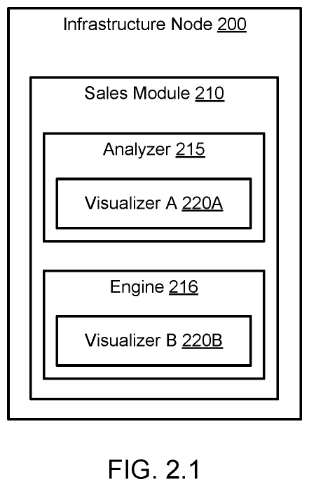

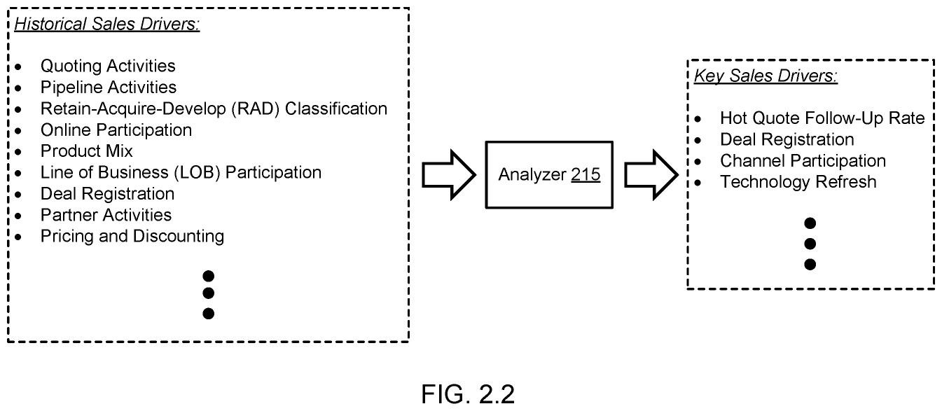

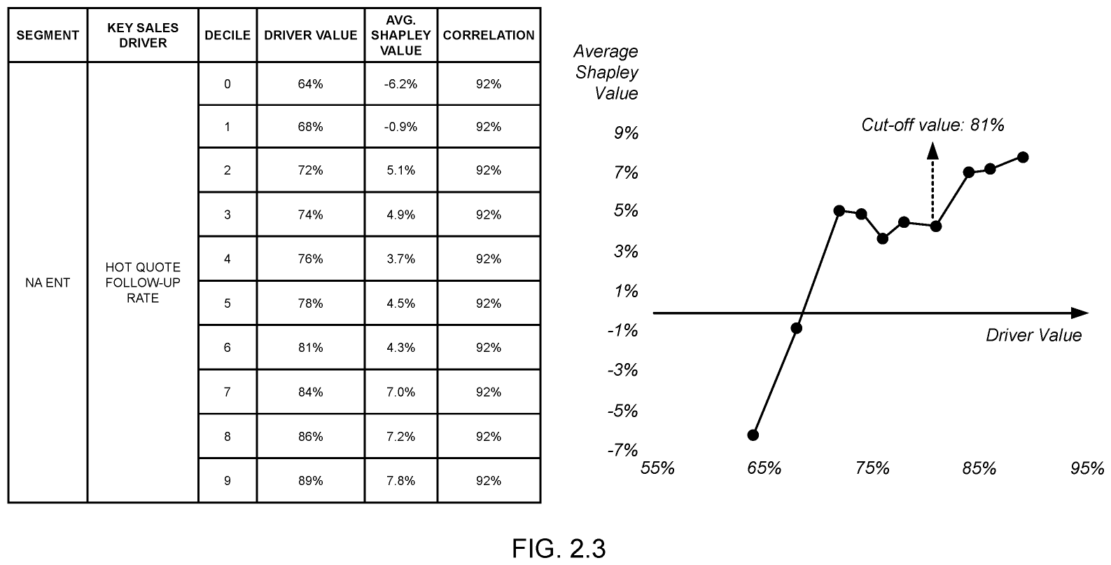

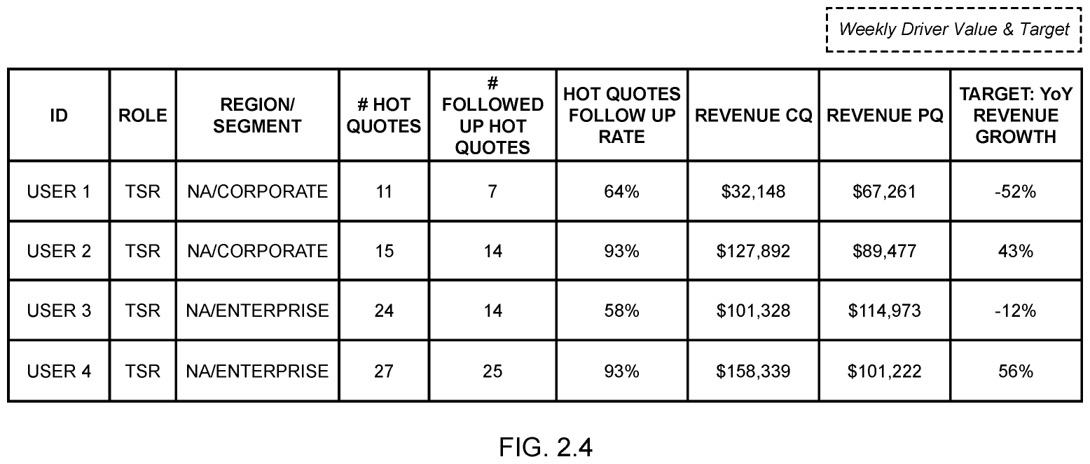

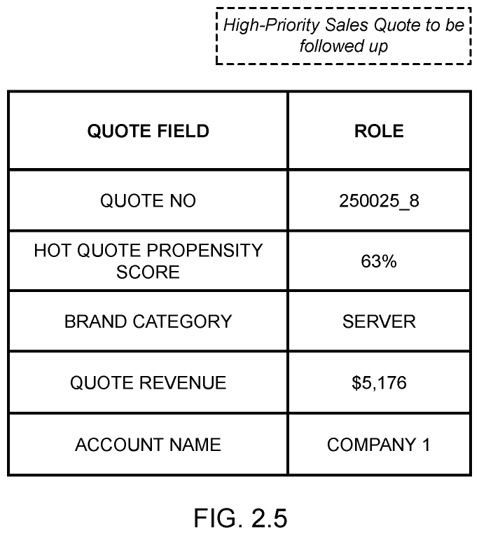

In one or more embodiments, the IN (120) may host a sales module (e.g., 210, FIG. 2.1). Additional details of the sales module are described below in reference to FIG. 2.1. In the embodiments of the present disclosure, the database (102) is demonstrated as a separate entity from the IN; however, embodiments disclosed herein are not limited as such. The database (102) may be demonstrated as a part of the IN (e.g., as deployed to the IN).

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network may be implemented using any combination of wired and/or wireless network topologies, and the network may be operably connected to the Internet or other networks. Further, the network (130) may enable interactions between, for example, the clients and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

Turning now to the database (102), the database (102) may provide long-term, durable, high read/write throughput data storage/protection with near-infinite scale and low-cost. The database (102) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. Further, the database (102) may also occupy a portion of a physical storage/memory device or, alternatively, may span across multiple physical storage/memory devices.

In one or more embodiments, the database (102) may be implemented using physical devices that provide data storage services (e.g., storing data and providing copies of previously stored data). The devices that provide data storage services may include hardware devices and/or logical devices. For example, the database (102) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (102) may include a memory device (e.g., a dual in-line memory device), in which data is stored and from which copies of previously stored data are provided. As yet another example, the database (102) may include a persistent storage device (e.g., an SSD), in which data is stored and from which copies of previously stored data is provided. As yet another example, the database (102) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (102) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the database (102) may store/log/record unstructured and/or structured data that may include (or specify), for example (but not limited to): an identifier of a user/customer; a financial service request (FSR) (discussed below) received from a user (or a user's account); an external parameter (or external information/data, discussed below) obtained from an external source; an internal parameter (or internal information/data, discussed below) generated internally within an organization (e.g., based on the organization's strategies and practices); one or more points-in-time and/or one or more periods of time associated with a sales event; telemetry data including past and present device usage of one or more computing devices; data for execution of applications/services including IN applications and associated end-points; corpuses of annotated data used to build/generate and train processing classifiers for trained ML models; linear, non-linear, and/or ML model parameters (discussed below); an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; an identifier of a user who initiated a sales pipeline (via a client); a distributed model identifier that uniquely identifies a distributed model; a user activity performed on a data item; a cumulative history of user/administrator activity records obtained over a prolonged period of time; a setting (and a version) of a mission critical application executing on the IN (120); configuration information associated with the sales module (e.g., 210, FIG. 2.1); a job detail of a job that has been initiated by the IN; a type of the job (e.g., a non-parallel processing job, a parallel processing job, an analytics job, etc.); information associated with a hardware resource set (discussed below) of the IN; a completion timestamp encoding a date and/or time reflective of the successful completion of a job; a time duration reflecting the length of time expended for executing and completing a job; a backup retention period associated with a data item; a status of a job (e.g., how many jobs are still active, how many jobs are completed, etc.); a number of requests handled (in parallel) per minute (or per second, per hour, etc.) by the analyzer (e.g., 215, FIG. 2.1); a number of errors encountered when handling a job; a documentation that shows how the analyzer performs against an SLO and/or an SLA; a set of requests received by the engine (e.g., 216, FIG. 2.1); a set of responses provided (by the engine) to those requests; information regarding an administrator (e.g., a high priority trusted administrator, a low priority trusted administrator, etc.) related to an analytics job; etc.

In one or more embodiments, an FSR may be one or more data structures that include FSR information. The FSR information may include (or specify), for example (but not limited to): a user identifier (e.g., a unique string or combination of bits associated with a particular user), an FSR type, hardware components and/or software components associated with the FSR, a geographic location (e.g., a country) associated with the user, a quantity of hardware components and/or software components associated with the FSR, compensation amount requested by the user, etc. The FSR may be generated by the user and/or an agent of the database (102). The FSR may be used by the analyzer (e.g., 215, FIG. 2.1) to generate FSR approval predictions.

In one or more embodiments, the model parameters may provide instructions (e.g., to the analyzer (e.g., 215, FIG. 2.1) and the engine (e.g., 216, FIG. 2.1)) on how to train their respective models. The model parameters may specify univariate and/or multivariate time series analysis approaches including (but not limited to): the seasonal autoregressive integrated moving average (SARIMA) approach, the time series linear model (TSLM) approach, the long short-term memory (LSTM) approach, etc.

In one or more embodiments, external information may include (or specify), for example (but not limited to): information obtained from a knowledge repository (and/or from a third-party application/service that includes resources accessible in a distributed manner via the network (130)) to aid processing operations of the sales module (e.g., 210, FIG. 2.1); data obtained from web-based resources (including cloud-based applications/services/agents); collected signal data (e.g., from usage of computing devices including retail devices and testing devices); data obtained for training and update of trained ML models (e.g., an analysis model, an insights model, etc.); information obtained from trained bots including those for natural language understanding; one or more historical actionable insights provided to an SR; etc.

In one or more embodiments, internal information may include (or specify), for example (but not limited to): data collected for training and update of trained ML models (e.g., an analysis model, an insights model, etc.); an identifier of a product; account group data (discussed below); data estimation regarding how much revenue is likely to be generated by the end of the quarter; data with respect to attainment of an SR; data identifying the risks in meeting the revenue target; data estimating demand in a sales pipeline (discussed below) to meet the revenue target; data quantifying the additional demand needed to mitigate the identified risks (e.g., in the event of a risk); historical revenue data; metrics of a sales pipeline (e.g., a size of a deal, a conversion rate, etc.) to more accurately forecast revenue; data with respect to different types of revenue (e.g., bids, run-rate, retail, enterprise sales, etc.) to more precisely identify which revenue sources may be leading or lagging; a revenue data entry; raw revenue data (discussed below); a time period that provides a date/time range for the raw revenue data (e.g., the time period may be set by taking the earliest and latest timestamps in the raw revenue data (e.g., March 2 to March 12, 14:30 to 18:50, etc.)), in which the time period may be a complete array of timestamps corresponding to all data in the raw revenue data; data indicating a geographic region (e.g., a city, a county, a province, a country, a country grouping, etc.) that indicates the geographic territory associated with the raw revenue data (e.g., North America (NA), Asia-Pacific-Japan (APJ), Texas, Paris, 645 main street, etc.), in which if the geographic region is “India”, the raw revenue data would pertain to revenue emanating from India; properties that include any other metadata relating to the raw revenue data; estimated values (e.g., interpolated, extrapolated, etc.) that are calculated (by the analyzer) to supplement missing values in the raw revenue data; time series parameters that are derived from the raw revenue data (by the analyzer via one or more analyses (e.g., seasonal decomposition, white noise test, etc.)); statistical data that includes one or more arrays of statistical analysis (performed by the analyzer) (e.g., any n-period exponential moving average (EMA), any n-period simple moving average (SMA), moving average convergence-divergence (MACD), last-four-quarters (LAQ) average, quantiles, lagged revenues (time shifted revenue variables to indicate seasonality), seasonally-adjusted revenues (removing seasonal trends to show only underlying trends), etc.); etc.

In one or more embodiments, internal information may further include (or specify), for example (but not limited to): historical sales entries (e.g., entries that include snapshots (e.g., copied data) of previously conducted sales pipeline processes); a historical timestamp that provides a date/time for when the associated static sales entry was accurate (e.g., having data that was “current” at the time of the historical timestamp); risk data (discussed below); a risk score that is an aggregated value calculated from one or more risk values of the risk data; a risk flag that is a binary indication of whether the related sales entry (or the historical sales entry) is considered as a “risky deal”; leadership strategic priorities (e.g., with respect to product lines, market share of a certain product, etc.) that are set based on an annual operation plan (AOP); one or more historical sales drivers (discussed below); etc.

In one or more embodiments, risk data is data that includes one or more risk factor(s) that are (a) identified in the associated sales entry and (b) associated with one or more risk value(s). In one or more embodiments, a risk factor is data specifying an identified risk in a sales entry, in which the risk factor include (or specify), for example (but not limited to): age of the deal (i.e., duration since the open date), decrease in monetary value, inactivity duration (i.e., duration since the last activity timestamp surpasses a threshold), multiple changes to the expected close date, low customer experience (e.g., because the corresponding SR has only been in the current position for three months), etc.

In one or more embodiments, a risk value is a numerical score assigned to each risk factor. A risk value is a quantitative measure of the “risk” associated with the risk factor. For example, if a risk factor is present because the age of the deal is 250 days old, there may be an associated risk factor of “5”. As yet another example, if a risk factor is present because the age of the deal is 500 days old, there may be an associated risk factor of “10”. As yet another example, a first risk factor indicating that the expected close date was moved back one day, may have an associated risk value of “1”, whereas a second risk factor indicating that the expected close date was moved back one month, may have an associated risk value of “20”. As indicated, in one or more embodiments, a risk factor that indicates more “risk” is assigned a higher risk value.

In one or more embodiments, account group data includes any data about any account, aggregated with all other accounts of interest. Such accounts may include a mix of offline accounts and online accounts. Such data may include any data about or otherwise related to an account. Examples include (but not limited to): revenue data; year-over-year (YoY) revenue growth data; expected future sales data; data indicating whether an account is a direct account or a channel account; percentage of revenue from services; data about a business unit handling account; total amount of transactions; data about distinct product lines of businesses; a buying frequency of a customer; etc. In one or more embodiments, account group data may be used (by the analyzer (e.g., 215, FIG. 2.1)) to obtain any number of derived data items, which are data items derived using other account group information. For example, various account group data items may be analyzed to determine derived data items related to account activity over time (e.g., revenue per transaction).

In one or more embodiments, raw revenue data is data that includes information recorded and collected from past events. Each piece of information in the raw revenue data may be associated with a specific time (e.g., in the raw revenue data). In one or more embodiments, raw revenue data may be organized based on the type of information (e.g., based on the associated revenue type) and/or based on a period of time (e.g., July 2020-October 2020). Further, raw revenue data may take the form of time series data that, over time, form discernable patterns in the underlying data. In the context of business and revenue forecasting, non-limiting examples of raw revenue data include (but not limited to): sales revenue of past transactions; a quantity of items sold/shipped/paid for; any other data that may be collected, measured, or calculated for business purposes; etc.

In one or more embodiments, a sales pipeline may include (or specify): a deal identifier (e.g., a tag, an alphanumeric entry, a filename, a row number in a table, etc.) that uniquely identifies a single deal associated with a sales entry (or a historical sales entry); a geographic region; a revenue type; a monetary value that equals the potential revenue that would be generated if the deal associated with the sales entry is fulfilled; user identifier(s) that uniquely identifies one or more user account(s) that are able to access (read) and/or edit (write) the associated sales entry; an open date that is the date/time when the deal associated with the sales entry was initiated (e.g., when a bid was offered, when a request-for-quote was received, etc.); an expected close date that is the date/time when the potential deal associated with the sales entry is expected to “close” (i.e., receive a commitment to purchase from the customer); a last activity timestamp that is the date/time when the last action (e.g., modification) for the deal was performed (e.g., an initial bid, an updated quote request, a notice that the seller is advancing in the bid process, etc.); a deal probability that represents the likelihood that the deal will be “closed” (or completed) (which may be calculated or input by a human/SR); a sales entry that is continually and automatically updated with newer data (as that data arrives) (e.g., if the monetary value of a deal changes, the value in the respective sales entry may be updated individually thereafter (i.e., not waiting for a push of multiple simultaneous updates scheduled to occur at once)); information with respect to a user/customer experience; etc.

In one or more embodiments, a historical sales driver may include (or specify) for example (but not limited to): a quoting activity, a pipeline activity (e.g., a sales pipeline generation), a retain-acquire-develop (RAD) classification, an online participation of a customer, a product mix (e.g., revenue generated from a customer as a result of offering a mix of different product lines), a line of business (LOB) participation of a customer, a deal registration of a customer (e.g., a registration of a sales deal between the customer and the corresponding SR), a partner activity (e.g., engagement points between the seller and partner in terms of enabling one or more sales to happen to a targeted customer), pricing information, discounting information, a tier of a partner (e.g., a high-privileged partner, a low-privileged partner, etc.), etc.

In one or more embodiments, information associated with a hardware resource set (e.g., including at least resource related parameters) may specify, for example (but not limited to): a configurable CPU option (e.g., a valid/legitimate vCPU count per IN), a configurable network resource option (e.g., enabling/disabling single-root input/output virtualization (SR-IOV) for the IN (120)), a configurable memory option (e.g., maximum and minimum memory per IN), a configurable GPU option (e.g., allowable scheduling policy and/or virtual GPU (vGPU) count combinations per IN), a configurable DPU option (e.g., legitimacy of disabling inter-integrated circuit (I2C) for various INs), a configurable storage space option (e.g., a list of disk cloning technologies across one or more INs), a configurable storage I/O option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per IN, a wake on LAN support configuration (e.g., supported/enabled, not supported/disabled, etc.), a vGPU count per IN, a type of a vGPU scheduling policy (e.g., a “fixed share” vGPU scheduling policy), a storage mode configuration (e.g., an enabled high-performance storage array mode), etc.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the database (102), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by vendors) and/or by the administrators based on, for example, newer (e.g., updated) versions of external information. The unstructured and/or structured data may also be updated when, for example (but not limited to): a set of FSRs is received, an ongoing sales pipeline job is fully completed, a state of the analyzer (e.g., 215, FIG. 2.1) is changed, etc.

While the database (102) has been illustrated and described as including a limited number and type of data, the database (102) may store additional, less, and/or different data without departing from the scope of the embodiments disclosed herein. One of ordinary skill will appreciate that the database (102) may perform other functionalities without departing from the scope of the embodiments disclosed herein.

While FIG. 1 shows a configuration of components, other system configurations may be used without departing from the scope of the embodiments disclosed herein.

Turning now to FIG. 2.1, FIG. 2.1 shows a diagram of an IN (200) in accordance with one or more embodiments disclosed herein. The IN (200) may be an example of the IN discussed above in reference to FIG. 1. The IN (200) includes a sales module (e.g., an LLM-based sales smart assistant) (210), which includes, at least, the analyzer (215) and the engine (216). The IN (200) may include additional, fewer, and/or different components without departing from the scope of the embodiments disclosed herein. Each component may be operably connected to any of the other component via any combination of wired and/or wireless connections. Each component illustrated in FIG. 2.1 is discussed below.

In one or more embodiments, the analyzer (215) may include functionality to, e.g.,: (i) generate, train, update, and implement an analysis model that is a combination of, for example, a random forest regression model and a Shapley framework at a role-region-segment level (e.g., which specifies at least a role of an SR (e.g., a technical SR, a specialist, etc.) in an organization, a region (e.g., NA, APJ, etc.) associated with the organization, and a segment (e.g., corporate, enterprise, etc.) associated with the organization); (ii) based on the analysis model (which includes the Shapley framework as an explainable AI approach (e.g., explaining the random forest regression model to an administrator)), identify the best performing cut-off (or threshold) values on key sales drivers (or key “actionable” drivers that have positive impact on revenue growth) (e.g., hot quote follow-up rate, deal registration, etc.) to enhance sales productivity (of an SR), recommend priority activities/drivers (to the SR), and contribute to increase revenue growth (of the SR); (iii) by employing a set of linear, non-linear, and/or ML models (e.g., the analysis model), analyze a variety of data points (e.g., from historical key sales drivers, see FIG. 2.2) that could be potential key/material drivers for YoY revenue growth (e.g., in which the analysis model may be trained with a target parameter that specifies increasing YoY revenue growth performance of the SR and increasing sales productivity of the SR); (iv) based on (iii), provide top priority key sales drives to the SR (catered specifically based on the SR's role-region-segment information) to focus on his/her potential YoY revenue growth (e.g., providing “hot quote follow-up” (a quote with the highest propensity to become an actual order) and “likely to buy (LTB)” (customers/accounts with the highest propensity to purchase a product in the current quarter) as the key sales drivers, along with a relevant threshold value that the SR must achieve for each of the key sales drivers to ensure the YoY revenue growth); (v) by employing a set of linear, non-linear, and/or ML models, analyze information regarding a user/customer (e.g., a high priority trusted user, a low priority trusted user, a malicious user, etc.) related to a request (e.g., an FSR, an order request, etc.); (vi) store mappings between an incoming request/call/network traffic and an outgoing request/call/network traffic in a mapping table of the database (e.g., 102, FIG. 1); (vii) store (e.g., in the database) (a) a cumulative history of user activity records obtained over a prolonged period of time, (b) a cumulative history of network traffic logs obtained over a prolonged period of time, (c) previously received malicious data access/retrieval requests from an invalid user, and/or (d) recently obtained customer/user information (e.g., records, credentials, etc.) of a user; (viii) receive a correspondence (e.g., a request in real-time or near real-time) from a customer, in which the correspondence may correspond to a question, an answer or any other communication the is generated by the customer and sent to the SR as part of a current (e.g., ongoing, live, etc.) session; (ix) by employing a set of linear, non-linear, and/or ML models, generate distributed prediction data from revenue data (e.g., by employing a distributed random forest model and using the monetary value of the revenue data and the open date associated with the revenue data, the analyzer may generate the distributed prediction data); (x) by combining two or more distributed prediction data and employing weighted averaging, generate composite prediction data, in which the weights may be assigned to each distributed prediction data by employing, for example, the ordinary least squares (OLS) model; and/or (xi) store (temporarily or permanently) the aforementioned data and/or the output(s) of the above-discussed processes in the database (e.g., 102, FIG. 1).

One of ordinary skill will appreciate that the analyzer (215) may perform other functionalities without departing from the scope of the embodiments disclosed herein. The analyzer may be implemented using hardware, software, or any combination thereof.

In one or more embodiments, a correspondence may be received in the form of digital audio data, text corresponding to a transcription of an audio signal (regardless of the type of audio signal), and/or text generated by a customer and sent, via a client (e.g., 110A, FIG. 1), to the analyzer (215). In one or more embodiments, while sending a correspondence, the client may use various different channels (e.g., paths), for example (but not limited to): product order channels, voice-based channels, virtual channels, etc.

In one or more embodiments, a correspondence may be generated on a client (e.g., 110A, FIG. 1) by encoding an audio signal in a digital form and then converting the resulting digital audio data into the correspondence. The conversion of the digital audio data into the correspondence may include applying an audio codec to the digital audio data, in order to compress the digital audio data prior to generating the correspondence. Further, the use of the audio codec may enable a smaller number of correspondences to be sent to the analyzer (215).

In one or more embodiments, if a correspondence is an audio signal, the analyzer (215) may convert the audio signal into text using any known or later discovered speech-to-text conversion application (which may be implemented in hardware, software, or any combination thereof), in order to process the audio signal and extract relevant data from it. Thereafter, the analyzer (215) may store the extracted data temporarily (until an ongoing conversation is over) or permanently in the database (e.g., 102, FIG. 1).

In one or more embodiments, even if the analyzer (215) may receive correspondences from a client (e.g., 110A, FIG. 1) in any format, the result of the processing of the received correspondences may be a text format of the correspondences. The text format of the correspondences may then be used by the other components (e.g., Visualizer A (220A)) of the sales module (210).

In one or more embodiments, as part of a model training step, the analyzer (215) may obtain the best performing (or the minimum) cut-off value of a key sales driver/metric (e.g., a value of the driver beyond which positive impact on YoY revenue growth (for the relevant role-region-segment) is projected) by first converting the key sales driver's actual value(s) into deciles. By obtaining average Shapley values of each decile and analyzing their correlation with the minimum key sales driver values (for that decile), the analyzer (215) may identify the minimum cut-off value beyond which a monotonic growth in Shapley values exist with the condition that the Shapley values are positive beyond the cut-off value (see FIG. 2.3). In this manner, the key sales drivers meeting these criteria may be designated as the “final qualifying drivers”, along with their respective cut-off values. Additional details of the aforementioned process are described below in reference to FIG. 2.3.

As described above, the local interpretability of each key sales driver provides information with respect to its impact on YoY revenue growth, and a change in the corresponding Shapley values (because of a change in the driver's actual values) may help the analyzer (215) (and/or the administrator) to determine the relationship between a change in the driver's actual values and a change in the corresponding Shapley values (from the perspective of the relationship's impact on YoY revenue growth). If both are highly correlated, then this outcome would help, for example, the administrator to conclude that the key sales driver is having a positive impact on the YoY revenue growth.

Turning now to Visualizer A (220A) (e.g., an API interface, a GUI, a programmatic interface, a communication channel, etc.), Visualizer A (220A) may include functionality to, e.g.,: (i) obtain (or receive) data (e.g., any type and/or quantity of input, a data search query, etc.) from any source (e.g., a user via a client (e.g., 110A, FIG. 1), an SR, etc.) (and, if necessary, aggregate the data); (ii) based on (i) and by employing a set of linear, non-linear, and/or ML models, analyze, for example, a query to derive additional data; (iii) encompass hardware and/or software components and functionalities provided by the IN (200) to operate as a service over the network (e.g., 130, FIG. 1) so that Visualizer A may be used externally; (iv) employ a set of subroutine definitions, protocols, and/or hardware/software components for enabling/facilitating communications between the analyzer (215) and external entities (e.g., the clients) such that the external entities may perform, for example, content-based data item search and/or retrieval (with minimum amount of latency (e.g., with high-throughput and sub-ms latency)) with respect to related SRs; (v) by generating one or more visual elements, allow an administrator and/or an SR (via a client) to view, interact with, and/or modify, for example, data of a dynamic sales pipeline and/or “visual” sales entries (described below); (vi) receive a grouping of key sales drivers (and corresponding details), and display the aforementioned content to an SR; (vii) receive an output of an analysis model (and corresponding details), and display the aforementioned content to an SR (for example, in a separate window(s)); (viii) concurrently display one or more separate windows; (ix) generate visualizations of methods illustrated in FIGS. 3.1-4.2; (x) receive a customer profile of a customer and display the customer profile to an SR; and/or (xi) receive an SR profile of an SR and display the SR profile to an administrator (e.g., for monitoring and/or performance evaluation).

One of ordinary skill will appreciate that Visualizer A (220A) may perform other functionalities without departing from the scope of the embodiments disclosed herein. Visualizer A may be implemented using hardware, software, or any combination thereof.

In one or more embodiments, a visual sales entry may include a sales entry table that provides a visual representation of data from the associated sales entry (e.g., a column for each component and the associated values in a shared row), in which (a) the sales entry table may be a single row table and (b) labeled columns may be shared among all visual sales entries. In one or more embodiments, a visual sales entry may include a user input where a user of Visualizer A (220A) may input data (e.g., an alphanumeric string) that is saved to the associated sales entry. The user input may provide a button to toggle, for example, a risk flag (e.g., on or off) in the associated sales entry and any changes made in the user input may be saved to the associated sales entry (e.g., stored in the database (e.g., 102, FIG. 1)).

Turning now to the engine (216), the engine (216) may include functionality to, e.g.,: (i) generate, train, update, and implement an insights model (e.g., an LLM that includes a neural network with various parameters, trained on large quantities of unlabeled text using self-supervised learning or semi-supervised learning); (ii) based on the insights model and specific actionable insights (e.g., key sales drivers) generated by the analyzer (215), provide additional/deeper information (e.g., external information with respect to the targeted customer/account, discussed above in reference to FIG. 1) to an SR to prioritize his/her activities towards revenue growth and sales productivity; (iii) (a) using the insights model and (b) based on both internal information and external information related to accounts and (analyzer) prioritized activities/drivers, generate insights (e.g., with respect to the targeted customer) and share those insights with the SR; and/or (iv) store (temporarily or permanently) the aforementioned data and/or the output(s) of the above-discussed processes in the database (e.g., 102, FIG. 1).

One of ordinary skill will appreciate that the engine (216) may perform other functionalities without departing from the scope of the embodiments disclosed herein. The engine may be implemented using hardware, software, or any combination thereof.

In one or more embodiments, the engine (216) may train (in conjunction with Visualizer B (220B)) the insights model by providing one or more customized prompts (to the insights model). To this end, the engine (216) may utilize quote-related internal information/parameters (e.g., historical SR activities (e.g., converted revenue range associated with the quoted product, in which this range may be derived from historical revenue and conversion data of historical quotes), historical account-specific insights (e.g., revenue and margin discount information associated with the quoted product, technical specifications of the quoted product, etc.), futuristic insights (e.g., customer-specific product recommendations), etc., obtained from the database (e.g., 102, FIG. 1)) and/or external information/parameters during the training process (so that, at the end, the trained model will be useful for an SR to make a relevant sales pitch to the corresponding customer in an automated manner, based on prioritized key sales drivers (generated by the analyzer (215))).

For example (e.g., example one), a prompt/question/instruction (given to the insights model) may be (or may specify):
“This account {account_name} has a hot quote (a quote that has high propensity to convert to an order) for product {product_quoted} quoted at {revenue_quoted} USD. The quoted {product_quoted} for a given configuration/specification has high chance of conversion at a revenue range of {converted_revenue_range}. The product {product_quoted} has following feature.”

Referring to the above example, technical specifications for the given product are summarized, stored, and indexed in a vector database (or an embedding store) (e.g., 102, FIG. 1) and retrieved (by the engine (216)) based on the product quoted. This example custom prompt may be generated for “Customer A” using one or more hot quote follow-up attributes/features discussed above (e.g., quote-related internal information/parameters).

As yet another example (e.g., example two), a prompt/question/instruction (given to the insights model) may be (or may specify):
Human (Administrator): “If I give you some paragraphs, can you use them to “generate insights for Account B” in a way it is useful for a follow-up with the customer as a sales representative at Organization D?”
Insights Model: “Yes. I will do that.”
Human: “Remember to only use information provided in the paragraphs for the account (and product) to answer questions. Do not answer questions you are not sure about.”
Insights Model: “Noted. Please provide me the paragraphs.”
Human: “Here they are.”

At this point, below template gets populated with relevant information for the corresponding account and its quote:
“This account {account_name} has a hot quote (a quote that has high propensity to convert to an order) for product {product_quoted} quoted at {revenue_quoted} USD. The quoted {product_quoted} for a given configuration/specification has high chance of conversion at a revenue range of {converted_revenue_range}. The product {product_quoted} has following feature.”

Thereafter, the insights model may generate the following answer (e.g., an account and product related output generated by the model):
Insights Model: “Account B has a hot quote for Product C750 quoted at 9,000 USD.”
Insights Model: “Product C750 has the following features: ”
Insights Model: “(i) designed to execute complex workloads; (ii) generation 2 CPUs; (iii) up to 32 DIMMs; (iv) PCIe generation 4.0 enabled expansion slots; (v) choice of network interface technologies; (vi) 3200 MT/s DDR4 memory; (vii) up to 10+2 PCIe SSD; (viii) suitable for data warehouses, e-commerce, and HPC; (ix) thermal restriction matric of 120 W CPU TDP and 150 W CPU cTDP with an STD fan; (x) includes an integrated Matrox G200 graphics controller with 16 MB of video frame buffer and USB ports; and (xi) Organization D offers a range of services for Product C750, including Deploy Plus, Basic Deployment, Server Configuration Services, Residency Services, Remote Consulting Services, and Data Migration Services.”

The aforementioned information (e.g., the quote-related output by the model) may be useful for a follow-up with the corresponding customer from the perspective of an SR in the following ways, e.g.,: (i) the hot quote has revenue of $9,000 but also has a scope of quoting around $7,000-8,000, as historically, this has been the quote conversion sweet spot for the given product configuration of Product C750; (ii) based on (i), the quote has a scope for further discount up to 22.2%; (iii) it has been five weeks since the quote became inactive, suggesting that a follow-up should be made within the specified timeframe of six weeks for hot quotes; and/or (iv) because this account has previously migrated to the YY platform, the quoted product (i.e., Product C750) should be a suitable fit for the customer/account.

Continuing with the discussion of the example two, the insights model may provide additional insights (based on external information) relevant to the account to the SR (see below). Referring to FIG. 1, the external information may be obtained/curated from web-based application/services to make the insights model up-to-date. In this manner, when the SR is pitching to customer, the SR would have access to latest digital, business, and/or technology transformation related information (to improve the chances of converting the quote into an actual order).
Human (Administrator): “What is the annual turnover/revenue of Account B in the current fiscal year?”
Insights Model: “According to the information that I found, Account B has an annual revenue of $75 million in 2022. I cannot provide exact dates for the information retrieved, but I can provide the following uniform resource locators (URLs) related to the information: URL one, URL two, etc.”
Human: “What are the business expansion plans of Account B for the next year?”
Insights Model: “Account B is planning to expand their portfolio of apparel brands, leveraging their decades of experience in the United States. They have acquired Company XX and Account RR to their roster of labels in order to ramp up their operations around the world. Here are the URLs: URL three, URL four, etc.”

Turning now to Visualizer B (220B) (e.g., an API interface, a GUI, a programmatic interface, a communication channel, etc.), Visualizer B (220B) may provide less, the same, or more functionalities and/or services (described above) comparing to Visualizer A (220A). One of ordinary skill will appreciate that Visualizer B (220B) may perform other functionalities without departing from the scope of the embodiments disclosed herein. Visualizer B may be implemented using hardware, software, or any combination thereof.

In one or more embodiments, the analyzer (215), the engine (216), Visualizer A (220A), and Visualizer B (220B) may be utilized in isolation and/or in combination to provide the above-discussed functionalities. These functionalities may be invoked using any communication model including, for example, message passing state sharing, memory sharing, etc. While FIG. 2.1 shows a configuration of components, other system configurations may be used without departing from the scope of the embodiments disclosed herein.

Turning now to FIG. 2.2, FIG. 2.2 shows example historical sales drivers and example key sales drivers in accordance with one or more embodiments disclosed herein. Referring to FIG. 2.2, a historical sales driver may include (or specify) for example (but not limited to): a quoting activity, a pipeline activity (e.g., a sales pipeline generation), a RAD classification, an online participation of a customer, a product mix (e.g., revenue generated from a customer as a result of offering a mix of different product lines), an LOB participation of a customer, a deal registration of a customer (e.g., a registration of a sales deal between the customer and the corresponding SR), a partner activity (e.g., engagement points between the seller and partner in terms of enabling one or more sales to happen to a targeted customer), pricing information, discounting information, a tier of a partner (e.g., a high-privileged partner, a low-privileged partner, etc.), e-pen mix (e.g., providing online and/or offline (e.g., without using the Internet or specially designed customer online portals) purchasing channels to a customer/entity, in which those channels may be managed by an SR), etc.

In one or more embodiments, the analyzer (215) looks into a variety of data sources that may contribute to YoY revenue growth (or YoY revenue growth performance of an SR). To this end, the analyzer (215) may retrieve historical sales drivers from the database (e.g., 102, FIG. 1). By employing a set of linear, non-linear, and/or ML models (e.g., the analysis model along with a target parameter (e.g., YoY revenue growth)) and by considering each SR at a role-region-segment level, the analyzer (215) analyzes the historical sales drivers that could be potential key/material sales drivers/metrics to increase YoY revenue growth performance of the corresponding SR and to increase sales productivity of that SR.

As a result of the analysis, for example, the analyzer (215) may identify one or more specific actionable key performance indicators (e.g., key sales drivers, actionable insights for an SR to consider, etc., that may have a relatively larger impact on increasing sales productivity), for example (but not limited to): hot quote (e.g., a quote that is most likely to become an order, a deal that is most likely to receive a commitment to purchase from the customer/buyer, etc.) follow-up (or hot quote follow-up rate), deal registration, channel participation, technology refresh (e.g., based on customer intelligence (e.g., historical purchases made by customers), pitching a newer version of a server that the corresponding customer purchased two years ago), etc. In one or more embodiments, the set of models being used may inherently produce results that indicate variable (i.e., input data item) importance. Separately, the set of models being used may not produce a measure of variable importance and other approaches (e.g., the Fisher Score approach) may be used to derive relative variable/feature importance.

In one or more embodiments, key sales drivers may help businesses to derive quantitative factors impacting their revenue. By understanding the key factors/metrics that drive revenue, businesses may make better informed decisions about how to mitigate potential risks and capitalize on opportunities (e.g., for revenue growth and for meeting revenue targets). These drivers may be wielded to quantify risk and risk mitigation measures, allowing businesses to better understand the potential impact of different risks and how to address those risks. Further, these “role-region-segment” specific drivers may aid SRs in having a better understanding of risk drivers and to work with their managers and customers to mitigate the potential risks on time.

In one or more embodiments, while analyzing the historical sales drivers and based on additional factors related to sales activities (e.g., revenue data, growth data, projected future sales data, etc.), the analyzer (215) may group/cluster two or more accounts. To perform the clustering, the analyzer may employ a clustering model (e.g., k-means clustering model) without departing from the scope of embodiments disclosed herein.

Turning now to FIG. 2.3, FIG. 2.3 shows a portion of an analysis model (implemented by the analyzer (e.g., 215, FIG. 2.1)) in accordance with one or more embodiments disclosed herein. Referring to FIG. 2.2, for example, the analyzer (e.g., 215, FIG. 2.1) may identify “hot quote follow-up rate” as the most impactful driver at a role-region-segment level (e.g., “NA” as the region and “enterprise (ENT)” as the segment). To further identify a cut-off value of the “hot quote follow-up rate”, the analyzer (e.g., 215, FIG. 2.1) may employ the Shapley framework (more specifically, the analyzer may analyze a combination of (a) average Shapley values realized through local interpretability of the “hot quote follow-up rate” and (b) the correlation between the “hot quote follow-up rate” values and the average Shapley values).

Referring to FIG. 2.3, assume here that “hot quote follow-up rate” values are sorted in an ascending order and then divided into ten equal buckets (e.g., deciles), in which the lowest decile is demonstrated as “decile 0” and the highest decile is demonstrated as “decile 9”. Further, as indicated, the “hot quote follow-up rate” value is increasing from 64% (decile 0) to 89% (decile 9), in which each decile has, for example, 100 SRs.

By employing the Shapley framework and for each deciles minimum “driver value” (e.g., a minimum of the “hot quote follow-up rate” actual range for that decile), the analyzer (e.g., 215, FIG. 2.1) may analyze the corresponding minimum driver value's correlation with the corresponding average Shapley value (which represents revenue growth) for that decile. For example, for those SRs under decile 0 (e.g., for those SRs that have a “hot quote follow-up rate” value between 64% and 67.99%), the associated revenue growth shows a negative value (−6.2%) (e.g., a decline in the revenue growth in the past, indicating low performing SRs).

In one or more embodiments, when the analyzer (e.g., 215, FIG. 2.1) identifies a monotonic growth in the corresponding average Shapley values with respect to the change(s) in the corresponding minimum driver values, the analyzer would consider/assume that driver value as the cut-off value for the “hot quote follow-up rate”. As clearly plotted in FIG. 2.3, beyond 81% (or decile 6) (i.e., the cut-off value (or the best performing threshold) of the considered key sales driver), “hot quote follow-up rate” values show a constant increase (and also demonstrate a monotonic/positive growth in the average Shapley value) and this cut-off value is considered as a guidance value for the corresponding SR to ensure revenue growth and to increase his/her sales productivity. Further, (a) beyond decile 6, the plot sows a 92% correlation (between the “driver value” and the “average Shapley value”) and (b) in this decile, the average Shapley value is 4.3%.

In one or more embodiments, the aforementioned process may be repeated for other key sales drivers without departing from the scope of the embodiments disclosed herein.

Turning now to FIG. 2.4, FIG. 2.4 shows an example weekly driver value and target table in accordance with one or more embodiments disclosed herein.

Referring FIG. 2.4, assume here that the table (e.g., a table for weekly SR performance tracking) shows: (a) (i) an identifier (ID) of a first user/SR: USER 1; (ii) a role of the first user: technical sales representative (TSR); (iii) region/segment of the first user: NA/corporate; (iv) number of hot quotes the first user is responsible for: 11; (v) number of followed up hot quotes by the first user: 7; (vi) hot quotes follow-up rate of the first user: 64%; (vii) current quarter (CQ) revenue of the first user: $32,148; (viii) previous quarter (PQ) revenue of the first user: $67,261; and (ix) YoY revenue growth (performance) of the first user: −52 % ; (b) (i) an ID of a second user: USER 2; (ii) a role of the second user: TSR; (iii) region/segment of the second user: NA/corporate; (iv) number of hot quotes the second user is responsible for: 15; (v) number of followed up hot quotes by the second user: 14; (vi) hot quotes follow-up rate of the second user: 93%; (vii) CQ revenue of the first user: $127,892; (viii) PQ revenue of the second user: $89,477; and (ix) YoY revenue growth (performance) of the second user: 43%; (c) (i) an ID of a third user: USER 3; (ii) a role of the third user: TSR; (iii) region/segment of the second user: NA/enterprise; (iv) number of hot quotes the third user is responsible for: 24; (v) number of followed up hot quotes by the third user: 14; (vi) hot quotes follow-up rate of the third user: 58%; (vii) CQ revenue of the third user: $101,328; (viii) PQ revenue of the third user: $114,973; and (ix) YoY revenue growth (performance) of the third user: −12 % ; and (d) (i) an ID of a fourth user: USER 4; (ii) a role of the fourth user: TSR; (iii) region/segment of the second user: NA/enterprise; (iv) number of hot quotes the fourth user is responsible for: 27; (v) number of followed up hot quotes by the fourth user: 25; (vi) hot quotes follow-up rate of the fourth user: 93%; (vii) CQ revenue of the fourth user: $158,339; (viii) PQ revenue of the fourth user: $101,222; and (ix) YoY revenue growth (performance) of the fourth user: 56%.

In one or more embodiments, once the best performing threshold for, for example, the “hot quotes follow-up rate” driver (with the historical four quarters data) is obtained, performance of each of the corresponding SRs is tracked on this driver throughout the upcoming quarter to infer whether they have met their target threshold that would lead to potential YoY revenue growth. For example, USER 1 needs to achieve a target threshold value of 81% for the “hot quotes follow-up rate” driver to have potential YoY revenue growth. However, as of third week of the CQ, USER 1 is yet to realize revenue growth and USER 1's hot quotes follow-up rate is only 64%, which requires USER 1 to increase his/her performance (because USER 1 is underperforming).

As yet another example, USER 4 needs to achieve a target threshold value of 81% for the “hot quotes follow-up rate” driver to have potential YoY revenue growth. As of third week of the CQ, USER 4 has realized revenue growth and USER 4's hot quotes follow-up rate is 93%, which indicates USER 4 is a high performing SR.

Turning now to FIG. 2.5, FIG. 2.5 shows an example high-priority sales quote (to be followed up) in accordance with one or more embodiments disclosed herein. In one or more embodiments, once an SR know his/her prioritized activities (based on one or more key sales drivers) with historical information around the account/customer of interest and the sales activity to be carried out (with that customer), the engine (e.g., 216, FIG. 2.1) may provide additional information (internal and/or external information, based on the key sales drivers generated by the analyzer (e.g., 215, FIG. 2.1)) to the SR.

Referring to FIG. 2.5, as a result, the SR may receive a high-priority sales quote to be followed up, which may include (or specify) for example (but not limited to): an identifier of a quote (or a quote no) (e.g., 250025_8), a hot quote propensity score (associated with an account) (e.g., 63%), a brand category of a targeted product (e.g., a server), quote revenue (e.g., $5,176), an identifier of the account (e.g., COMPANY 1), etc.

FIG. 3.1 shows a method for generating an analysis model in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 3.1, the method shown in FIG. 3.1 may be executed by, for example, the above-discussed analyzer (e.g., 215, FIG. 2.1). Other components of the system (100) illustrated in FIG. 1 may also execute all or part of the method shown in FIG. 3.1 without departing from the scope of the embodiments disclosed herein.

In Step 300, the analyzer receives a request from a requesting entity (e.g., a user of a client (e.g., 110A, FIG. 1), an administrator terminal, an application, etc.) that wants to generate an analysis model that, at least, identifies one or more key sales drivers and their cut-off values.

In response to receiving the request, as part of that request, and/or in any other manner (e.g., before initiating any computation with respect to the request), the analyzer invokes the database (e.g., 102, FIG. 1) to communicate with the database. After receiving the database's confirmation, the analyzer obtains historical sales drivers (or “raw” historical sales drivers) from the database. In one or more embodiments, the historical sales drivers may be obtained continuously or at regular intervals (e.g., every 5 hours) (without affecting production workloads of the database and the analyzer). Further, data that includes the historical sales drivers may be access-protected for the transmission from, for example, the database to the analyzer, e.g., using encryption.

In one or more embodiments, the data may be obtained as it becomes available or by the analyzer polling the database (via one or more API calls) for newer information. For example, based on receiving an API call from the analyzer, the database may allow the analyzer to obtain newer information. Details of the historical sales drivers are described above in reference to FIG. 1.

In Step 302, by employing a set of linear, non-linear, and/or ML models, the analyzer analyzes the historical sales drivers (obtained in Step 300) to generate the analysis model (e.g., an ML/AI model that is based on a random forest regression model and a Shapley framework at a role-region-segment level) that identifies one or more key sales drivers and their cut-off values (e.g., their best performing threshold values). In one or more embodiments, threshold values may allow flexibility to the corresponding SR while keeping an AOP on track, which in turn may generate insights about the SR's performance and help administrators to provide timely correction/support for each region/portfolio (if necessary).

In one or more embodiments, with the help of the analysis model, the analyzer (i) may be able to build an association between a corresponding key sales driver and revenue growth (e.g., one of the outcomes of the analysis model is an interpretable form of how each and every key sales driver impacts revenue growth (e.g., the target variable/parameter)) and (ii) may be able to obtain more granular information with respect to one or more accounts.

In one or more embodiments, before generating the analysis model, the analyzer may obtain one or more model parameters (from the database) that provide instructions on how to identify the key sales drivers and their target cut-off values. The model parameters may also specify one or more ML models, including (but not limited to): a random forest regression model a neural network model, a logistic regression model, the K-nearest neighbor model, the extreme gradient boosting (XGBoost) model, a Naïve Bayes classification model, a support vector machines (SVM) model, etc.

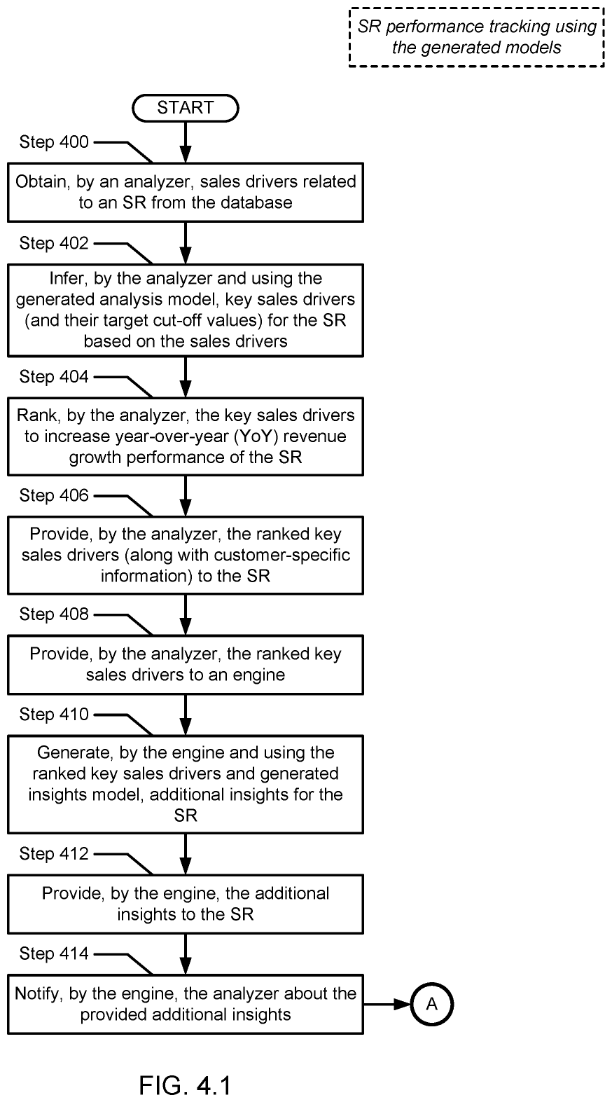

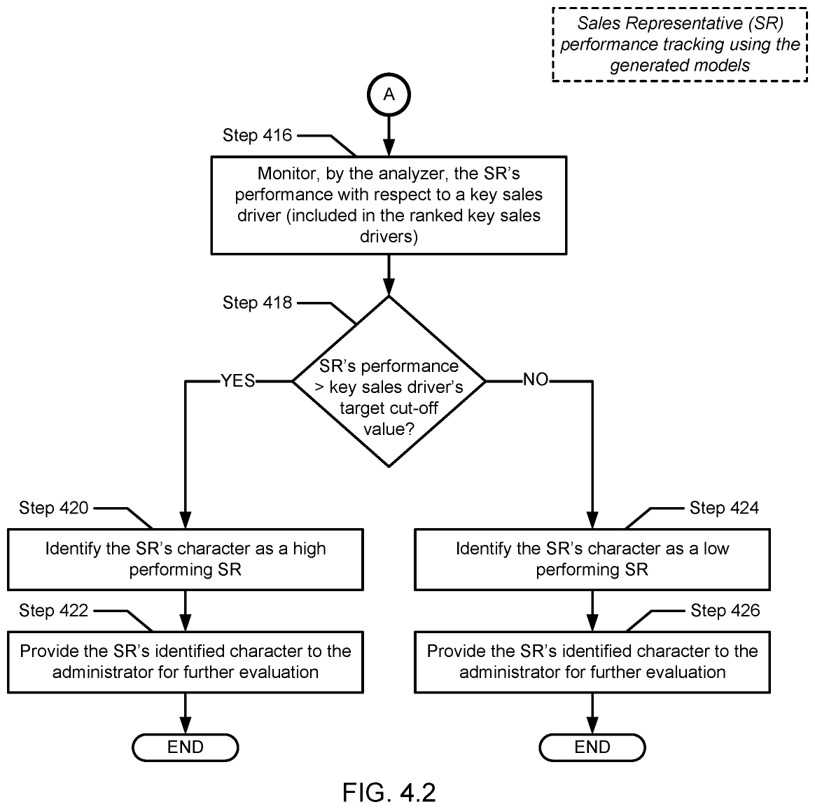

In Step 304, based on the target variable/parameter and instructions, the analyzer generates the analysis model and trains that model to obtain a “trained” analysis model. In order to train the analysis model, the analyzer may use, at least, the historical sales drivers. In one or more embodiments, the “trained” analysis model may then be used for inferencing purposes (or for the “inferencing phase”, see FIG. 4.1). In one or more embodiments, the trained model may also be designed to minimize errors by using a set of sub-models that extracts/infers information from the historical sales drivers and aligns with a business perspective of revenue and pipeline.

In one or more embodiments, the analysis model may be trained using a single deal over time. That is, when the model is trained by the analyzer, each of the multiple historical sales drivers may have the same deal identifier, but having different historical timestamps. Further, as the same deal may be used during the training process, geographic region (of one or more SRs) and revenue type may be considered as additional factors.

In one or more embodiments, the trained analysis model may be adapted to execute specific determinations described herein with reference to any component of the system (e.g., 100, FIG. 1) and processing operations executed thereby.

For example, the analysis model may be specifically trained and adapted for execution of processing operations including (but not limited to): data collection (e.g., collection of device data from a user of a computing device); testing device data to execute prior to a full product release; a corpus of training data including feedback on update estimates from prior iterations of the trained analysis model; identification of parameters for generation of update estimates by the trained analysis model as well as correlation of parameters usable to generate update estimates; labeling of parameters for generation of update estimates; hyperparameter tuning of identified parameters associated with generating an update estimate; selection of applicable trained analysis models; generation of data insights per training to update estimates; generating notifications (e.g., GUI notifications) including update estimates and/or related data insights; execution of relevance scoring/ranking analysis for generating data insights including insights for suggesting alternative time frames to apply updates relative to an update estimate; etc.

In one or more embodiments, as the trained analysis model is a learning model, accuracy of the model may be improved over time through iterations of training, receipt of user feedbacks, etc. Further, training the analysis model may include application of a training algorithm. As an example, a decision tree (e.g., a Gradient Boosting Decision Tree) may be used to train the analysis model. In doing so, one or more types of decision tree algorithms may be applied for generating any number of decision trees to fine-tune the analysis model. In one or more embodiments, training of the analysis model may further include generating an ML/AI model that is tuned to reflect specific metrics for accuracy, precision and/or recall before the trained ML/AI model is exposed for real-time (or near

In Step 306, after generating the trained analysis model (in Step 304) (e.g., after the analysis model is ready for inferencing), the analyzer initiates notification of an administrator/user (of the corresponding client) about the generated and trained analysis model. The notification may include, for example (but not limited to): for what purpose the model has been trained, the range of SRs that has been taken into account while training the model, the amount of time that has been spent while performing the training process, etc.

In one or more embodiments, the notification may also indicate whether the training process was completed within the predetermined window, or whether the process was completed after exceeding the predetermined window. The notification may be displayed on a GUI of the corresponding client. In one or more embodiments, the method may end following Step 306.

FIG. 3.2 shows a method for generating an insights model in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 3.2, the method shown in FIG. 3.2 may be executed by, for example, the above-discussed engine (e.g., 216, FIG. 2.1). Other components of the system (100) illustrated in FIG. 1 may also execute all or part of the method shown in FIG. 3.2 without departing from the scope of the embodiments disclosed herein.

In Step 310, the engine receives a second request from the requesting entity that wants to generate an insights model that, at least, provides specific sales insights to an SR.

In response to receiving the second request, as part of that request, and/or in any other manner (e.g., before initiating any computation with respect to the second request), the engine invokes the database to communicate with the database. After receiving the database's confirmation, the engine obtains historical key sales drivers and one or more internal parameters from the database. In one or more embodiments, the aforementioned data may be obtained continuously or at regular intervals (without affecting production workloads of the database and the engine). Further, the aforementioned data may be access-protected for the transmission from, for example, the database to the engine, e.g., using encryption.

In one or more embodiments, the aforementioned data may be obtained as it becomes available or by the engine polling the database (via one or more API calls) for newer information. For example, based on receiving an API call from the engine, the database may allow the engine to obtain newer information.

In Step 312, in response to receiving the second request, as part of that request, and/or in any other manner (e.g., before initiating any computation with respect to the second request), the engine further obtains external parameters (e.g., recent account/customer news) from one or more external sources (e.g., web-based resources (including cloud-based applications/services/agents)). Details of the external parameters are described above in reference to FIG. 1.

In Step 314, by employing a set of linear, non-linear, and/or ML models, the engine analyzes the historical key sales drivers (obtained in Step 310), internal parameters (obtained in Step 310), and external parameters (obtained in Step 312) to generate the insights model (e.g., an ML/AI model) that provides specific insights (e.g., valuable sales insights, a comprehensive account overview, etc.) to the corresponding SR. In one or more embodiments, specific insights may offer “customer conversational points” to the SR to improve chances of pipeline/quote/order conversion (e.g., sales productivity) while keeping the AOP on track.

In one or more embodiments, before generating the insights model, the engine may obtain one or more model parameters (from the database) that provide instructions on how to provide specific sales insights. The model parameters may also specify one or more ML models, including (but not limited to): a random forest regression model a neural network model, a logistic regression model, the K-nearest neighbor model, the XGBoost model, a Naïve Bayes classification model, an SVM model, etc.

In Step 316, based on the target variable and instructions, the engine generates the insights model and trains that model to obtain a “trained” insights model. In order to train the insights model, the engine may use, at least, the historical key sales drivers, internal parameters, and external parameters. In one or more embodiments, the “trained” insights model may then be used for inferencing purposes (or for the “inferencing phase”, see FIG. 4.1). In one or more embodiments, the trained model may also be designed to minimize errors by using a set of sub-models that extracts/infers information from the historical key sales drivers, internal parameters, and/or external parameters and aligns with a business perspective of revenue and pipeline.

In one or more embodiments, the insights model may be trained using a single deal over time. That is, when the model is trained by the engine, each of the multiple historical key sales drivers may include the same deal identifier, but having different historical timestamps. Further, as the same deal may be used during the training process, geographic region (specified in the internal and/or external parameters) and revenue type may be considered as additional factors.

In one or more embodiments, the trained insights model may be adapted to execute specific determinations described herein with reference to any component of the system (e.g., 100, FIG. 1) and processing operations executed thereby.

In one or more embodiments, as the trained insights model is a learning model, accuracy of the model may be improved over time through iterations of training, receipt of user feedbacks, etc. Further, training the insights model may include application of a training algorithm. As an example, a decision tree (e.g., a Gradient Boosting Decision Tree) may be used to train the insights model. In doing so, one or more types of decision tree algorithms may be applied for generating any number of decision trees to fine-tune the insights model. In one or more embodiments, training of the insights model may further include generating an ML/AI model that is tuned to reflect specific metrics for accuracy, precision and/or recall before the trained ML/AI model is exposed for real-time (or near real-time) usage (see FIG. 4.1).

In Step 318, after generating the trained insights model (in Step 316) (e.g., after the insights model is ready for inferencing), the engine initiates notification of the administrator (of the corresponding client) about the generated and trained insights model. The notification may include, for example (but not limited to): for what purpose the model has been trained, the range of SRs that has been taken into account while training the model, the amount of time that has been spent while performing the training process, etc.

In one or more embodiments, the notification may also indicate whether the training process was completed within the predetermined window, or whether the process was completed after exceeding the predetermined window. The notification may be displayed on a GUI of the corresponding client. In one or more embodiments, the method may end following Step 318.

FIGS. 4.1 and 4.2 shows a method for SR performance tracking (using the generated models in FIGS. 3.1 and 3.2) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 4.1, the method shown in FIG. 4.1 may be executed by, for example, the above-discussed analyzer and engine. Other components of the system (100) illustrated in FIG. 1 may also execute all or part of the method shown in FIG. 4.1 without departing from the scope of the embodiments disclosed herein.

In Step 400, the analyzer receives a request from the requesting entity that wants to track performance of an SR. In response to receiving the request, as part of that request, and/or in any other manner (e.g., before initiating any computation with respect to the request), the analyzer invokes the database to communicate with the database. After receiving the database's confirmation, the analyzer obtains sales drivers (e.g., current versions of one or more historical sales drivers) related to the SR from the database. In one or more embodiments, the sales drivers may be obtained continuously or at regular intervals (without affecting production workloads of the database and the analyzer). Further, data that includes the sales drivers may be access-protected for the transmission from, for example, the database to the analyzer, e.g., using encryption.

In one or more embodiments, the data may be obtained as it becomes available or by the analyzer polling the database (via one or more API calls) for newer information. For example, based on receiving an API call from the analyzer, the database may allow the analyzer to obtain newer information.

In Step 402, (i) upon obtaining the sales drivers and (ii) by employing the trained analysis model, the analyzer infers one or more key sales drivers (and their target cut-off values) for the SR (at the role-region-segment level). In one or more embodiments, with the help of the trained analysis model, the analyzer (i) may be able to build an association between a corresponding key sales driver and revenue growth and (ii) may be able to obtain more granular information with respect to one or more accounts.

In one or more embodiments, if the trained analysis model is not operating properly (e.g., is not providing the above-discussed functionalities), the model may be re-trained using any form of training data and/or the model may be updated periodically as there are improvements in the model (e.g., the model may be trained using more appropriate training data). In one or more embodiments, upon inferring the key sales drivers, the analyzer may store/write (temporarily or permanently) a copy of the key sales drivers in the database.

In Step 404, the analyzer ranks the key sales drivers to increase YoY revenue growth performance of the SR. In one or more embodiments, by employing any model, the analyzer may rank a key sales driver (of the key sales drivers) that will cause the SR to reach the highest YoY revenue growth as the highest ranked driver (e.g., top priority driver).

In Step 406, the analyzer provides the ranked key sales drivers (along with the customer-specific information (e.g., discount information, product information, etc., deduced from the internal parameters) and the corresponding cut-off value for each of the drivers that the SR needs to achieve to ensure revenue growth) to the SR. For example, the SR may receive (from the analyzer) an action notification (via a GUI of the corresponding client) that specifies at least specific sales activities (e.g., the ranked key sales drivers) that should be prioritized for the SR, along with an explanation about why these activities need to be prioritized (with the help of the Shapley framework). In one or more embodiments, at this point, the SR is aware of his/her prioritized sales activity to be carried out (or acted upon) (e.g., hot quotes follow-up/closure), along with the customer-specific information around the account of interest.

In Step 408, the analyzer provides the ranked key sales drivers to the engine. In Step 410, based on the ranked key sales drivers and by employing the trained insights model, the engine generates additional insights for the SR, in which the additional insights may include internal parameters (e.g., product-related information such as cost of a product targeted by the customer, specifications of that product, etc.) and/or external parameters (e.g., information with respect to the customer's funding, IT strategy, etc.).

In one or more embodiments, if the trained insights model is not operating properly (e.g., is not providing the above-discussed functionalities), the model may be re-trained using any form of training data and/or the model may be updated periodically as there are improvements in the model (e.g., the model may be trained using more appropriate training data).

In Step 412, the engine provides the additional insights to the SR, in which the additional insights may be helpful to the SR (i) to make a relevant sales pitch to the customer (to close the deal/quote) and (ii) to achieve his/her revenue growth target (which is related to the cut-off value of the corresponding key sales driver). Thereafter, in Step 414, the engine notifies the analyzer about the provided additional insights.

Turning now to FIG. 4.2, the method shown in FIG. 4.2 may be executed by, for example, the above-discussed analyzer. Other components of the system (100) illustrated in FIG. 1 may also execute all or part of the method shown in FIG. 4.2 without departing from the scope of the embodiments disclosed herein.

In Step 416, through its SR performance monitoring service, the analyzer periodically monitors (e.g., on a weekly basis throughout the corresponding quarter) the SR's (service) performance with respect to a key sales driver (e.g., the highest ranked driver in the ranked key sales driver) and the additional insights. The analyzer may monitor the SR (e.g., through actions being performed by the SR, customer communications being conducted, etc.) because the SR may need to generate a sales pipeline (e.g., to engage demand) and need to meet his/her revenue growth target for a given quarter. To satisfy his/her revenue target, it may be vital to evaluate the SR's performance for sales opportunities/deals in advance, activate the SR or another SR on specific opportunities for specific customers, and mitigate any risk factors that may prevent a deal from moving forward.

In Step 418, based on Step 416, the analyzer makes a determination (in real-time or near real-time) as to whether the SR's performance exceeds the corresponding key sales driver's “target” cut-off value. Accordingly, in one or more embodiments, if the result of the determination is YES (indicating that the SR shows consistent positive performance to satisfy his/her revenue growth target), the method proceeds to Step 420. If the result of the determination is NO (indicating that a risk/low performance flag/alert should be set for the SR), the method alternatively proceeds to Step 424.

In Step 420, as a result of the determination in Step 418 being YES, the analyzer identifies/tags/labels the SR's identified character as a high performing SR. In Step 422, via a score on its visualizer (e.g., Visualizer A (e.g., 220A, FIG. 2.1)), the analyzer provides the SR's identified character to the administrator/manager for further evaluation. To this end, the administrator may (i) be aware of the flag(s) generated for the SR and (ii) track the SR's performance with respect to contribute to YoY revenue growth.

Upon receiving the SR's identified character, the administrator may decide not to send a recommendation to the SR (because the administrator has already been satisfied with the SR's revenue growth performance). In one or more embodiments, the method may end following Step 422.

In Step 424, as a result of the determination in Step 418 being NO, the analyzer identifies/tags/labels the SR's identified character as a low performing SR. In Step 426, via a score on its visualizer (where each SR may be represented with a different color (e.g., red color tones may represent low performing SRs and green color tones may represent high performing SRs)), the analyzer provides the SR's identified character to the administrator for further evaluation. To this end, the administrator may (i) be aware of the flag(s) generated for the SR and (ii) track the SR's performance with respect to contribute to YoY revenue growth.

Upon receiving the SR's identified character, the administrator may decide to send, via the analyzer, a recommendation (e.g., a request, a command, etc., as a proactive action) (or multiple recommendation with minimum amount of latency) to the SR (because the administrator does not satisfy with the SR's revenue growth performance), in which the recommendation may specify one or more actions/next steps that needs to be taken by the SR to help the SR to achieve his/her target revenue growth and improve his/her performance (with respect to, for example, targeted hot quote follow-up rate).

In one or more embodiments, the analyzer may include a recommendation monitoring service to monitor whether the provided recommendation is implemented/considered by the SR. The recommendation monitoring service may be a computer program that may be executed on the underlying hardware of the analyzer. Based on monitoring, if the SR's performance has not been changed over time (even after the SR implemented the provided recommendation), the administrator may send a second recommendation (for a better SR experience/satisfaction and/or customer satisfaction) to the SR. The analyzer may then store (temporarily or permanently) the recommendations in the database. In one or more embodiments, the method may end following Step 426.

Turning now to FIG. 5, FIG. 5 shows a diagram of a computing device in accordance with one or more embodiments disclosed herein.

In one or more embodiments disclosed herein, the computing device (500) may include one or more computer processors (502), non-persistent storage (504) (e.g., volatile memory, such as RAM, cache memory), persistent storage (506) (e.g., a non-transitory computer readable medium, a hard disk, an optical drive such as a CD drive or a DVD drive, a Flash memory, etc.), a communication interface (512) (e.g., Bluetooth interface, infrared interface, network interface, optical interface, etc.), an input device(s) (510), an output device(s) (508), and numerous other elements (not shown) and functionalities. Each of these components is described below.

In one or more embodiments, the computer processor(s) (502) may be an integrated circuit for processing instructions. For example, the computer processor(s) (502) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (e.g., a LAN, a WAN, Internet, mobile network, etc.) and/or to another device, such as another computing device.

In one or more embodiments, the computing device (500) may include one or more output devices (508), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing a sales representative's (SR) performance, the method comprising:
obtaining, by an analyzer, historical sales drivers (HSDs);
generating, by the analyzer and using the HSDs, an analysis model that identifies a set of key sales drivers and target cut-off values associated with the set of key sales drivers;
obtaining, by the analyzer and based on a target parameter, a trained analysis model, wherein the analysis model is trained using at least the HSDs;
obtaining, by an engine, historical key sales drivers (HKSDs), internal parameters (IPs), and external parameters (EPS);
analyzing, by the engine, the HKSDs, the IPs, and the EPs to generate an insights model that provides an insight for the SR;
obtaining, by the engine and based on the target parameter, a trained insights model, wherein the insights model is trained using at least the HKSDs, the IPs, and the EPs;
inferring, by the analyzer and using the trained analysis model, a key sales driver for the SR and a target cut-off value associated with the key sales driver, wherein the set of key sales drivers comprises at least the key sales driver, wherein the key sales driver is provided to the SR and to the engine;
generating, by the engine and using the trained insights model and the key sales driver, a second insight for the SR, wherein the second insight is provided to the SR;
monitoring, by the analyzer, the SR's performance with respect to the key sales driver and the second insight;
in response to the monitoring, by the analyzer, making a determination that the SR's performance is above the target cut-off value;
identifying, based on the determination and by the analyzer, the SR as a high performing SR; and
initiating, by the analyzer, displaying of a score to an administrator, wherein the score indicates the SR as the high performing SR.

2. The method of claim 1, wherein the HSDs comprise at least one selected from a group consisting of a quoting activity performed by a second SR, online participation information of a customer, line of business (LOB) information shared with the customer, information with respect to retain-acquire-develop (RAD) approach followed by an organization that shares the LOB information with the customer, and a sales activity performed by a partner that is employed by the organization.

3. The method of claim 1, wherein the analysis model is a combination of a random forest regression model and a framework that explains the random forest regression model to the administrator.

4. The method of claim 3, wherein the framework is a Shapley framework, wherein the analysis model implements the Shapley framework at a role-region-segment level, wherein the role-region-segment level specifies at least a role of the SR in an organization, a region associated with the organization, and a segment associated with the organization.

5. The method of claim 1, wherein the target parameter specifies increasing a year-over-year (YoY) revenue growth performance of the SR and increasing a sales productivity of the SR.

6. The method of claim 5, wherein the key sales driver specifies an activity that is expected to have a positive impact on increasing the YoY revenue growth performance of the SR, wherein the activity is a hot quote follow-up with a customer.

7. The method of claim 1, wherein the IPs comprise at least one selected from a group consisting of a historical revenue obtained for a product that is delivered to a customer, a historical quote associated with the product, and a technical specification of the product.

8. The method of claim 1, wherein the EPs comprise at least one selected from a group consisting of an annual revenue of the customer during a last fiscal year, a business expansion plan of the customer for a next year, and a total number of employees hired by the customer during the last fiscal year.

9. The method of claim 1, wherein being above the target cut-off value indicates a positive impact on a year-over-year (YoY) revenue growth performance of the SR.

10. A method for managing a sales representative's (SR) performance, the method comprising:
obtaining, by an analyzer, historical sales drivers (HSDs);
generating, by the analyzer and using the HSDs, an analysis model that identifies a set of key sales drivers and target cut-off values associated with the set of key sales drivers;
obtaining, by the analyzer and based on a target parameter, a trained analysis model, wherein the analysis model is trained using at least the HSDs;
obtaining, by an engine, historical key sales drivers (HKSDs), internal parameters (IPs), and external parameters (EPs);
analyzing, by the engine, the HKSDs, the IPs, and the EPs to generate an insights model that provides an insight for the SR;
obtaining, by the engine and based on the target parameter, a trained insights model, wherein the insights model is trained using at least the HKSDs, the IPs, and the EPs;
notifying, by the engine, the analyzer about the trained insights model; and
initiating, by the analyzer, notification of an administrator about the trained analysis model and the trained insights model.

11. The method of claim 10, further comprising:
after the notification of the administrator:
inferring, by the analyzer and using the trained analysis model, a key sales driver for the SR and a target cut-off value associated with the key sales driver, wherein the set of key sales drivers comprises at least the key sales driver, wherein the key sales driver is provided to the SR and to the engine;
generating, by the engine and using the trained insights model and the key sales driver, a second insight for the SR, wherein the second insight is provided to the SR;
monitoring, by the analyzer, the SR's performance with respect to the key sales driver and the second insight;
in response to the monitoring, by the analyzer, making a determination that the SR's performance is above the target cut-off value;
identifying, based on the determination and by the analyzer, the SR as a high performing SR; and
initiating, by the analyzer, displaying of a score to administrator, wherein the score indicates the SR as the high performing SR.

12. The method of claim 10, wherein the HSDs comprise at least one selected from a group consisting of a quoting activity performed by a second SR, online participation information of a customer, line of business (LOB) information shared with the customer, information with respect to retain-acquire-develop (RAD) approach followed by an organization that shares the LOB information with the customer, and a sales activity associated with a partner that is employed by the organization.

13. The method of claim 10, wherein the analysis model is a combination of a random forest regression model and a framework that explains the random forest regression model to the administrator.

14. The method of claim 13, wherein the framework is a Shapley framework, wherein the analysis model implements the Shapley framework at a role-region-segment level, wherein the role-region-segment level specifies at least a role of the SR in an organization, a region associated with the organization, and a segment associated with the organization.

15. The method of claim 10, wherein the target parameter specifies increasing a year-over-year (YoY) revenue growth performance of the SR and increasing a sales productivity of the SR.

16. The method of claim 15, wherein the key sales driver specifies an activity that is expected to have a positive impact on increasing the YoY revenue growth performance of the SR, wherein the activity is a hot quote follow-up with a customer.

17. The method of claim 10, wherein the IPs comprise at least one selected from a group consisting of a historical revenue obtained for a product that is delivered to a customer, a historical quote associated with the product, and a technical specification of the product.

18. A method for managing a sales representative's (SR) performance, the method comprising:
inferring, by the analyzer and using a trained analysis model, a key sales driver for the SR and a target cut-off value associated with the key sales driver, wherein the set of key sales drivers comprises at least the key sales driver, wherein the key sales driver is provided to the SR and to the engine;
generating, by the engine and using the trained insights model and the key sales driver, a second insight for the SR, wherein the second insight is provided to the SR;
monitoring, by the analyzer, the SR's performance with respect to the key sales driver and the second insight;
in response to the monitoring, by the analyzer, making a determination that the SR's performance is above the target cut-off value;
identifying, based on the determination and by the analyzer, the SR as a high performing SR; and
initiating, by the analyzer, displaying of a score to an administrator, wherein the score indicates the SR as the high performing SR.

19. The method of claim 18, further comprising:
prior to the inferring the key sales driver for the SR and the target cut-off value associated with the key sales driver:
obtaining, by the analyzer, historical sales drivers (HSDs);
generating, by the analyzer and using the HSDs, an analysis model that identifies a set of key sales drivers and target cut-off values associated with the set of key sales drivers;
obtaining, by the analyzer and based on a target parameter, the trained analysis model, wherein the analysis model is trained using at least the HSDs;
obtaining, by the engine, historical key sales drivers (HKSDs), internal parameters (IPs), and external parameters (EPs);
analyzing, by the engine, the HKSDs, the IPs, and the EPs to generate an insights model that provides an insight for the SR;
obtaining, by the engine and based on the target parameter, the trained insights model, wherein the insights model is trained using at least the HKSDs, the IPs, and the EPs;
notifying, by the engine, the analyzer about the trained insights model; and
initiating, by the analyzer, notification of the administrator about the trained analysis model and the trained insights model.

20. The method of claim 19, wherein the HSDs comprise at least one selected from a group consisting of a quoting activity performed by a second SR, online participation information of a customer, line of business (LOB) information shared with the customer, information with respect to retain-acquire-develop (RAD) approach followed by an organization that shares the LOB information with the customer, and a sales activity associated with a partner that is employed by the organization.
